(19) United States
(12) Patent Application Publication
(10) Pub. No.: US 2021/0336241 A1
(43) Pub. Date: Oct. 28, 2021

(54) SYSTEM AND METHOD FOR MANUFACTURING ELECTRODE FOR SECONDARY BATTERY

(71) Applicants: Hyundai Motor Company, Seoul (KR); Kia Motors Corporation, Seoul (KR)

(72) Inventors: Hannah SONG, Ansan-si (KR); Daehyeon JOUNG, Seongnam-si (KR); Kyeong Wi PARK, Suwon-si (KR); Sung Hoon JEONG, Seoul (KR)

(73) Assignees: Hyundai Motor Company, Seoul (KR); Kia Motors Corporation, Seoul (KR)

(21) Appl. No.: 17/018,927

(22) Filed: Sep. 11, 2020

(30) Foreign Application Priority Data
Apr. 28, 2020 (KR) 10-2020-0051780

(51) Int. Cl. H01M 4/04; H01M 4/36; H01M 4/139; H01M 4/62; H01M 10/0525

(52) U.S. Cl. CPC H01M 4/0435; H01M 4/0471; H01M 10/0525; H01M 4/139; H01M 4/621; H01M 4/364

(57) ABSTRACT

A system for manufacturing an electrode for a secondary battery includes, a mixing unit forming a fibrillated mixture by fibrillating a powder mixture of active material powder, binder powder, and conductive material powder, a forming unit forming a mixture film by the fibrillated mixture, a pressurizing unit uniformizing a thickness of the mixture film by pressurizing rollers to form an electrode component film, first and second winding rolls each supplied and wound with the electrode component film from the pressurizing unit, a base material film roll located between first and second winding rolls and wound with a base material film, and a lamination unit configured to heat and cool to form a junction of the first electrode component film, the base material film, and the second electrode component film that are consecutively stacked.

### CROSS-REFERENCE TO RELATED APPLICATION

The present application claims priority to Korean Patent Application No. 10-2020-0051780 filed on Apr. 28, 2020, the entire contents of which is incorporated herein for all purposes by this reference.

### BACKGROUND OF THE INVENTION

### Field of the Invention

The present invention relates to a system and method for manufacturing an electrode for a secondary battery.

### Description of Related Art

In general, secondary batteries have been applied to fields of small apparatuses such as mobile devices and laptop computers, but recently, the research direction has been expanded to a field of medium and large size apparatuses, for example, to a field requiring high power such as an energy storage systems (ESS), an electric vehicles (EV), etc.

In the case of such a medium-to-large size secondary battery, unlike a small size battery, the operation environment (e.g., temperature or impact) is typically more severe. Furthermore, since more battery power is to be used, it is necessary to secure safety as well as excellent performance or an appropriate price.

The secondary battery includes a battery using lithium ions (such as a lithium ion battery, a lithium-sulfur battery, a lithium metal battery, and the like) using a liquid or polymer electrolyte, and also a solid state battery using a solid electrolyte.

Most lithium secondary batteries that are currently commercially available use organic liquid electrolytes in which lithium salt is dissolved in an organic solvent, and thus present a potential danger of ignition and explosion, including leakage.

In fact, since the explosion accident of such secondary batteries is continuously reported, it is important to solve the present problem.

Solve such a problem with a separate safety apparatus, there is a demerit in that energy density may be lost due to the considerable weight occupied by the safety apparatus, and basically there is a limit to overcome the safety problem by use of an organic liquid electrolyte solution.

To solve the above problems, the development of a solid state battery using a solid electrolyte instead of a liquid electrolyte solution is in progress.

Since the solid state battery does not include a flammable organic solvent, it has the advantage of simplifying the safety apparatus, and thus it is regarded as batteries that show excellence in production cost and productivity.

The solid state battery has a junction structure that a solid electrolyte layer is located between a pair of electrode layers of a positive electrode layer and a negative electrode layer. Since such a junction structure may be easily stacked in series, it is expected to be a stable technology for manufacturing high-capacity and high-power batteries.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing system and method for manufacturing an electrode for a secondary battery having advantages of providing double sided electrode using a dry process, increasing a volumetric efficiency of an electrode, increasing an energy density of a battery, and reducing a material cost.

An exemplary system for manufacturing an electrode for a secondary battery includes, a mixing unit supplied with active material powder, binder powder, and conductive material powder, forming a fibrillated mixture by fibrillating a powder mixture of the active material powder, the binder powder, and the conductive material powder, and automatically discharging the fibrillated mixture, a forming unit configured to form a mixture film by the fibrillated mixture discharged from the mixing unit, a pressurizing unit supplied with the mixture film from the forming unit and uniformizing a thickness of the mixture film by a pair of pressurizing rollers to form an electrode component film, a first winding roll and a second winding roll each supplied with the electrode component film from the pressurizing unit and winding the electrode component film, a base material film roll located between first and second winding rolls and wound with a base material film, and a lamination unit supplied with a first electrode component film from the first winding roll, a base material film from the base material film roll, and a second electrode component film from the second winding roll, and configured to heat and cool to form a junction of the first electrode component film, the base material film, and the second electrode component film that are consecutively stacked.

The mixing unit may include a mixing chamber formed in a cylindrical shape, supplied with the active material powder, the binder powder, and the conductive material powder, and having a rear end portion tapered to form an outlet having a slot to discharge the fibrillated mixture, and a rotation member mounted in a longitudinal direction inside the mixing chamber, and connected to a drive motor to be rotatable by the drive motor, and fibrillating the powder mixture by dissolving the binder powder to generate a binding force between the active material powder and the active material powder, and between the active material powder and the conductive material powder.

The rotation member may include a screw fixedly mounted on the rotation member, a diameter of the screw gradually increasing toward a downstream side such that a gap between the screw and an internal surface of the mixing chamber is narrowed toward the downstream side thereof.

The mixing unit may further include a preheating chamber that surrounds a predetermined range of an external surface of the mixing chamber, and provides heat to the powder mixture inside the mixing chamber.

The forming unit may be configured at a rear of the mixing unit, and films the fibrillated mixture discharged from the mixing chamber by a forming frame connected to the outlet.

The forming frame may include an upper frame and a lower frame that are detachable with each other, and a shape of the fibrillated mixture may be varied by varying a forming slit between the upper frame and lower frame.

The mixing unit may include a mixing chamber formed in a closed box shape and storing the active material powder, the binder powder, and the conductive material powder, a rotation member mounted inside the mixing chamber and rotated by a drive motor outside the mixing chamber to dissolve the binder powder to fibrillate the powder mixture, and a feeder connected to the mixing chamber through a connection pipe, and configured to discharge the fibrillated mixture formed by the rotation member through a discharge slot formed at a lower end portion of the feeder.

The rotation member may include a mixing blade maintaining a predetermined gap with an internal surface of the mixing chamber.

The discharge slot may be formed with a slot length greater than or equal to the width of the first and second winding rolls.

The forming unit may include a pair of forming rollers configured to film the fibrillated mixture by squeezing, at both sides of the discharge slot, the fibrillated mixture discharged through the discharge slot, and a pressurizing cylinder pressing a first forming roller of the pair of forming rollers toward a second forming roller of the pair of forming rollers to generate a pressurizing force.

The exemplary system may further include a cutting unit mounted between the forming unit and pressurizing unit, and configured to uniformly cut both side edges of the mixture film supplied from the forming unit to the pressurizing unit.

The lamination unit may include a heating portion configured to heat the stack of the first electrode component film, the base material film, and the second electrode component film to form adhesiveness of binder contained in the first electrode component film and the second electrode component film.

The lamination unit may include a heating portion configured to heat the base material film supplied from the base material film roll prior to stacking the base material film between the first electrode component film and the second electrode component film, and a cooling portion configured to cool the first electrode component film and the second electrode component film joined with and heated by the base material film.

An exemplary method for manufacturing an electrode for a secondary battery includes, forming a fibrillated mixture by fibrillating a powder mixture of active material powder, binder powder, and conductive material powder by a mixing unit, forming a mixture film by filming the fibrillated mixture supplied from the mixing unit by a pressurizing force of a forming unit, forming a first electrode component film and a second electrode component film by uniformizing a thickness of the mixture film by a pair of pressurizing rollers of a pressurizing unit, winding the first electrode component film on a first winding roll and the second electrode component film on a second winding roll, and forming an electrode for the secondary battery by forming junction by heating, laminating, and cooling a consecutive stack of the first electrode component film, a base material film, and the second electrode component film that are supplied from the first winding roll, a base material film roll, and the second winding roll, respectively.

The forming of the fibrillated mixture may include supplying the active material powder, the binder powder, and the conductive material powder to a mixing chamber of the mixing unit, and generating a binding force between the active material powder and the active material powder and between the active material powder and the conductive material powder by dissolving the binder powder between the mixing chamber and a rotation member inside the mixing chamber.

The exemplary method may further include, after forming the mixture film and before forming the first and second electrode component films, uniformly cutting both side edges of the mixture film by a cutting unit.

The forming of the electrode for a secondary battery may include disposing the base material film roll between the first winding roll and the second winding roll, supplying the first electrode component film, the base material film, and the second electrode component film to a lamination unit in a consecutive stack, and laminating the consecutive stack of the first electrode component film, the base material film, and the second electrode component film.

The exemplary method may further include, after forming the electrode for a secondary battery, winding the electrode for the secondary battery on an electrode roll.

Therefore, according to system and method for manufacturing an electrode for a secondary battery according to various exemplary embodiments of the present invention, since a double-sided electrode for a secondary battery is manufactured by use of a dry process, the thickness of the electrode of the battery may be reduced, increasing a volumetric efficiency of the electrode and improving the energy density of the battery.

Furthermore, system and method for manufacturing an electrode for a secondary battery according to various exemplary embodiments of the present invention, the usage of base material and separators required in manufacturing a secondary battery are reduced, reducing the material cost.

Other effects which may be obtained or are predicted by an exemplary embodiment will be explicitly or implicitly described in a detailed description of the present invention. That is, various effects that are predicted according to an exemplary embodiment will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a system for manufacturing an electrode for a secondary battery according to an exemplary embodiment of the present invention.

FIG. 2 is a schematic diagram of a mixing unit and a forming unit applied to a system for manufacturing an electrode for a secondary battery according to an exemplary embodiment of the present invention.

FIG. 3 is a schematic diagram of a cutting unit applied to a system for manufacturing an electrode for a secondary battery according to an exemplary embodiment of the present invention.

FIG. 4 and FIG. 5 are schematic diagrams of a lamination unit applied to a system for manufacturing an electrode for a secondary battery according to an exemplary embodiment of the present invention.

FIG. 6 is a schematic diagram of a system for manufacturing an electrode for a secondary battery according to another exemplary embodiment of the present invention.

FIG. 7 is a schematic diagram of a forming unit applied to a system for manufacturing an electrode for a secondary battery according to another exemplary embodiment of the present invention.

FIG. 8 is a flowchart showing a method for manufacturing an electrode for a secondary battery according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of the present application will be described more fully hereinafter with reference to the accompanying drawings, in which exemplary embodiments of the present invention are shown. As those skilled in the art would realize, the described embodiments may be modified in various different ways, all without departing from the spirit or scope of the present invention.

To clarify the present invention, portions that are not connected to the description will be omitted, and the same elements or equivalents are referred to with the same reference numerals throughout the specification.

In the following description, dividing names of components into first, second, and the like is to divide the names because the names of the components are the same as each other, and an order thereof is not particularly limited.

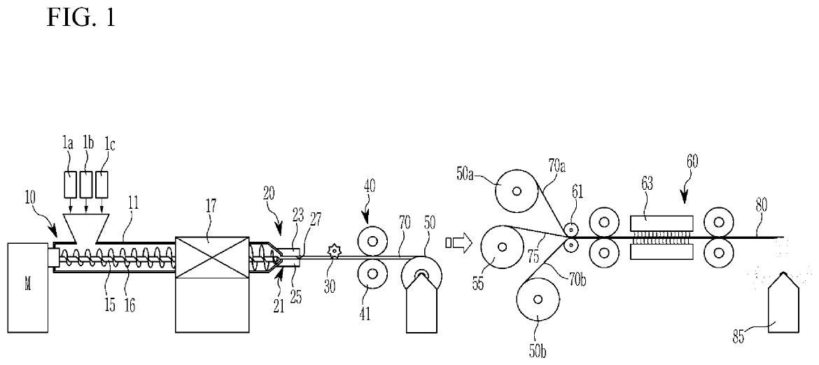

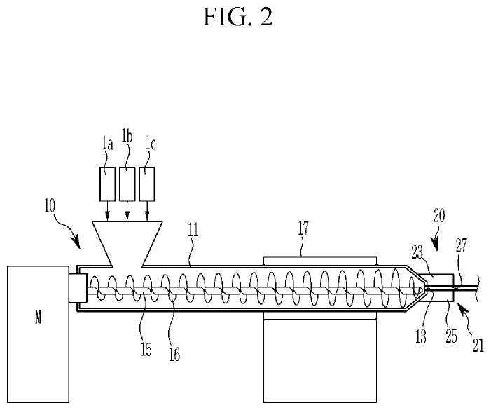

FIG. 1 is a schematic diagram of a system for manufacturing an electrode for a secondary battery according to an exemplary embodiment of the present invention. FIG. 2 is a schematic diagram of a mixing unit and a forming unit applied to a system for manufacturing an electrode for a secondary battery according to an exemplary embodiment of the present invention.

However, in various exemplary embodiments of the present invention, front and rear, left and right, and upward and downward directions in FIG. 1 are taken as reference directions.

The above definition of reference directions has relative meanings, and may not necessarily limited thereto since directionality may vary depending on reference positions of the exemplary system or constituent portions employed therein

According to various exemplary embodiments of the present invention, with reference to the drawings, a portion facing upwards is called an upper portion, an upper end portion, an upper surface, and an upper end portion, and a portion facing downwards is referred to as a lower portion, a lower end portion, a lower surface, and a lower end portion.

Furthermore, hereinafter, an “end (one end portion, another end portion, and the like)” may be defined as any one end portion or may be defined as a portion (one end portion, another end portion, and the like) including that end portion.

A system for manufacturing an electrode for a secondary battery according to an exemplary embodiment and manufacturing apparatus is for manufacture an electrode for a secondary battery by a dry process instead of a conventional wet process.

The secondary battery includes a battery using lithium ions (such as a lithium ion battery, a lithium-sulfur battery, a lithium metal battery, and the like) using a liquid or polymer electrolyte, and also a solid state battery using a solid electrolyte.

In various exemplary embodiments of the present invention, only active material powder, binder powder, and conductive material powder are used to manufacture electrodes before impregnation with various electrolytes.

For such a purpose, referring to FIG. 1 and FIG. 2, a system for manufacturing an electrode for a secondary battery according to various exemplary embodiments of the present invention includes a mixing unit 10, a forming unit 20, a cutting unit 30, a pressurizing unit 40, a winding roll 50, and a lamination unit 60.

The mixing unit 10 includes a mixing chamber 11 supplied with active material powder, binder powder, and conductive material powder, from an active material powder container 1a, a binder powder container 1b, and a conductive material powder container 1c, which respectively stores the active material powder, the binder powder, and the conductive material powder.

At the present time, the conductive material powder may be solid electrolyte powder for a solid state battery.

The mixing chamber 11 may be formed in a cylindrical shape having a circular cross-section.

Furthermore, the mixing chamber 11 has a rear end portion formed in a tapered shape, and a cross-section gradually decreases toward the rear.

An outlet 13 is formed at an end portion of the mixing chamber 11, and the outlet 13 is formed as a slot of a predetermined length.

That is, the mixing chamber 11 has the outlet 13 in a form of the slot at the rear end portion of which the cross-section is gradually decreased.

A rotation member 15 is mounted inside the mixing chamber 11, and the rotation member 15 may include a screw 16 mounted thereon

At the present time, the rotation member 15 is mounted in a longitudinal direction inside the mixing chamber 11, and connected to and connected to a drive motor to be rotatable by the drive motor M.

Furthermore, the screw 16 is formed to have a larger overall diameter toward a downstream side, and as a result, a gap between the screw 16 and an internal circumference of the mixing chamber 11 is gradually decreased toward the downstream side thereof.

That is, the mixing chamber 11 has a structure in which the active material powder, the binder powder, and the conductive material powder receive more frictional force between the screw 16 and the mixing chamber 11 as they go to the downstream side thereof.

The mixing unit 10 is configured to form a powder mixture by mixing the active material powder, the binder powder, and the conductive material powder inside the mixing chamber 11, and to form a fibrillated mixture by fibrillating the powder mixture by a rotation of the screw 16.

That is, the binder powder is dissolved as the screw 16 rotates, and as the binder powder is dissolved, a binding force is generated between the active material powder and the active material powder, and between the active material powder and the conductive material powder, respectively.

At the present time, when the secondary battery is a solid state battery, the binding force may be generated between the solid electrolyte powder and the conductive material powder, and between the solid electrolyte powder and the active material powder, respectively.

As the screw 16 rotates, the powder mixture is gradually transformed to the fibrillated mixture while moving toward the downstream side along the mixing chamber 11, and when there is no more free space in the mixing chamber 11, the fibrillated mixture is automatically discharged through the outlet 13.

At the present time, a shape of the fibrillated mixture may depend on a shape of the outlet 13.

That is, the shape of the fibrillated mixture may be determined by a width or a length of the outlet 13.

Furthermore, the mixing unit 10 includes a preheating chamber 17 disposed at a rear portion of the mixing chamber 11 to surround an external surface of the mixing chamber 11.

That is, the preheating chamber 17 surrounds a predetermined range of the external surface of the mixing chamber 11, and provides heat to the powder mixture inside the mixing chamber 11 to easily transform the powder mixture to the fibrillated mixture during the fibrillation of the powder mixture.

Such a preheating chamber 17 may be selectively operated depending on the type of the powder mixture.

For example, the preheating chamber 17 may include a heating coil surrounding the external surface of the mixing chamber 11.

The forming unit 20 is configured at a rear of the mixing unit 10.

The forming unit 20 is configured to film the fibrillated mixture formed at the mixing unit 10.

The forming unit 20 includes a forming frame 21 disposed at the rear of the mixing chamber 11 and connected to the outlet 13. The fibrillated mixture is pressurized in the forming frame 21 to be filmed by changing the shape of the fibrillated mixture.

Here, the forming frame 21 may include an upper frame 23 and a lower frame 25.

In more detail, the forming frame 21 forms a forming slit 27 formed between the upper frame 23 and the lower frame 25 that are detachable from each other, and the forming slit 27 is connected to the outlet 13. The forming slit 27 is formed with narrower cross-section than the outlet 13. Therefore, the fibrillated mixture automatically discharged from the outlet 13 is squeezed while passing through the forming slit 27, and thereby filmed according to the shape of the forming slit 27. Furthermore, the shape (e.g., thickness) of the fibrillated mixture may be varied by varying the forming slit between the detachable upper and lower frames 23 and 25, i.e., by use of different upper and lower frames 23 and 25.

At the present time, a shear force is generated and applied to the fibrillated mixture, and thereby the fibrillated mixture is formed to a mixture film 71 in a film shape.

The cutting unit 30 is configured at a rear of the forming unit 20.

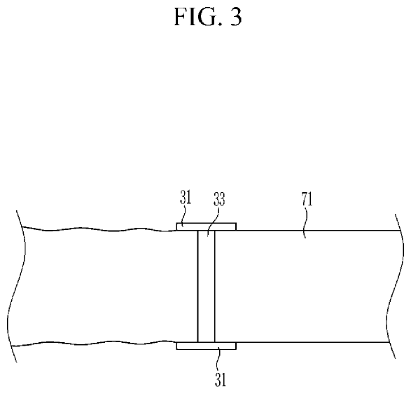

FIG. 3 is a schematic diagram of a cutting unit applied to a system for manufacturing an electrode for a solid state battery according to an exemplary embodiment of the present invention.

FIG. 3 illustrates the cutting unit 30 as viewed from the top.

Referring to FIG. 3, the cutting unit 30 uniformly cuts both side edges of the mixture film 71 automatically discharged from the forming unit 20.

That is, the cutting unit 30 cuts non-uniform edge portions of an electrode 80 for a secondary battery to be manufactured. For the present purpose, the cutting unit 30 is provided with cutter blades 31 are formed at both sides corresponding to a width of the electrode 80 for a secondary battery, and both side edges of the mixture film 71 automatically discharged from the forming unit 20 is uniformly cut by the cutter blades 31.

The cutter blades 31 are disposed at both sides of a rotation shaft 33 and simultaneously rotate to cut the mixture film 71.

Referring back to FIG. 1, the pressurizing unit 40 is configured at a rear of the cutting unit 30.

The pressurizing unit 40 includes a pair of pressurizing rollers 41.

The mixture film 71 having the edge portion uniformly cut by the cutting unit 30 is pressurized by the pressurizing unit 40 in a thickness direction thereof, and thereby the thickness of the mixture film 71 is uniformed to form an electrode component film 70.

The pressurizing unit 40 may change the thickness of the mixture film 71 by adjusting the gap between a pair of pressurizing rollers 41.

The winding roll 50 is disposed at a rear of the pressurizing unit 40.

The winding roll 50 refers to a unit body in which the electrode component film 70 passed through the pressurizing unit 40 is wound by a predetermined length.

A cutter is disposed in front of the winding roll 50 to cut the electrode component film 70 when the electrode component film 70 is wound on the winding roll 50 for a predetermined length.

In the present way, a first electrode component film 70a is wound on a first winding roll 50a, and a second electrode component film 70b is wound on a second winding roll 50b. Meanwhile, a base material film 75 is wound on a base material film roll 55.

The lamination unit 60 is disposed at a rear of the winding roll 50.

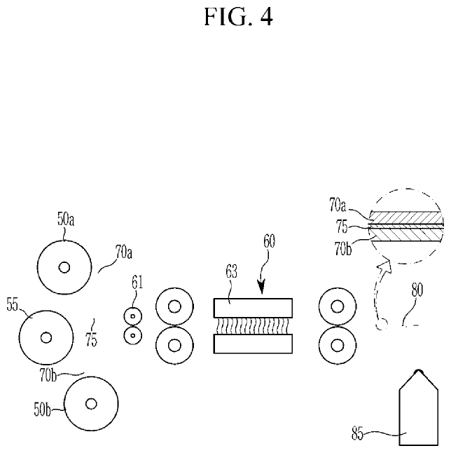

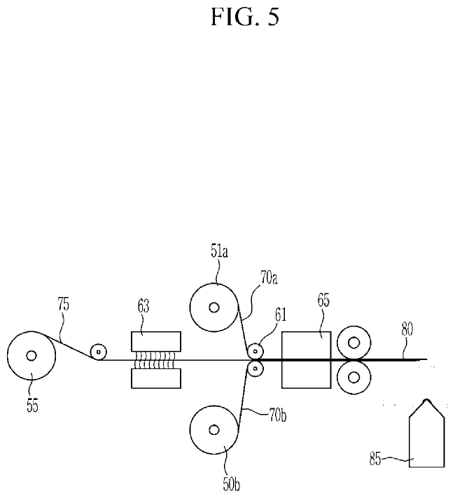

FIG. 4 and FIG. 5 are schematic diagrams of a lamination unit applied to a system for manufacturing an electrode for a solid state battery according to an exemplary embodiment of the present invention.

Referring to FIG. 4, the first and second winding rolls 50a and 50b and the base material film roll 55 are disposed in front of the lamination unit 60.

The first electrode component film 70a wound on the first winding roll 50a, the base material film 75 wound on the base material film roll 55, and the second electrode component film 70b wound on a second winding roll 50b are supplied to the lamination unit 60. In the instant case, the first electrode component film 70a, the base material film 75, and the second electrode component film 70b are supplied to the lamination unit 60, in a state that the base material film 75 located between the first electrode component film 70a and the second electrode component film 70b.

At the present time, a guide roller 61 is disposed at a front end portion of the lamination unit 60 such that the first electrode component film 70a, the base material film 75, and the second electrode component film 70b are supplied while overlapping in the order of the first electrode component film 70a, the base material film 75, and the second electrode component film 70b.

The lamination unit 60 includes a heating portion 63.

The heating portion 63 heats the first electrode component film 70a, the base material film 75, and the second electrode component film 70b that are consecutively stacked. Therefore, adhesiveness is provided to the binder contained in the first and second electrode component films 70a and 70b, respectively. The first electrode component film 70a, the base material film 75, and the second electrode component film 70b are mutually conjoined by the adhesiveness.

At the present time, the heating portion 63 may heat the junction of the films 70a, 75, and 70b in a range of 50° C. to 150° C.

Meanwhile, as an alternative variation, the lamination unit 60 may be formed as follows.

Referring to FIG. 5, in the lamination unit 60, the heating portion 63 is disposed at a rear of the base material film roll 55 to heat the base material film 75 first.

The heated base material film 75 is located between the first electrode component film 70a and the second electrode component film 70b, and by the heated base material film 75, adhesiveness is provided to the binder contained in the first electrode component film 70a and the second electrode component film 70b. The first electrode component film 70a, the base material film 75, and the second electrode component film 70b are mutually conjoined by the adhesiveness.

At the present time, the heating portion 63 may heat the base material film 75 in a range of 50° C. to 150° C.

Furthermore, the lamination unit may further include a cooling portion 65 in addition to the heating portion 63.

The cooling portion 65 cools, e.g., in a range of 5° C. to 10° C., the junction of the first electrode component film 70a, the base material film 75, and the second electrode component film 70b formed while passing through the heating portion 63, and thereby forms the electrode 80 for a secondary battery.

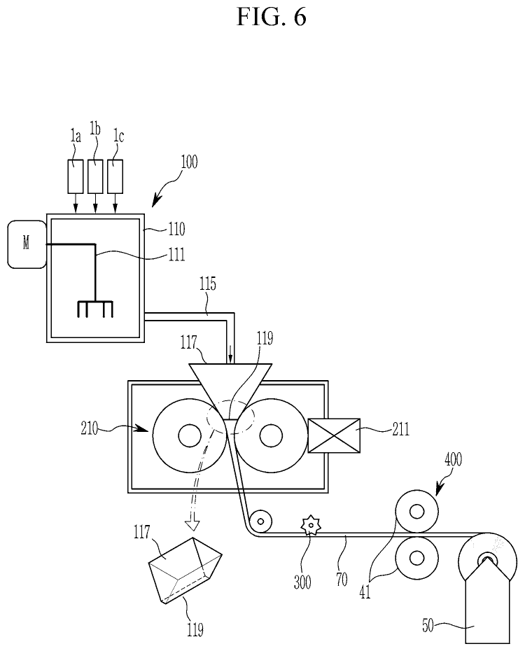

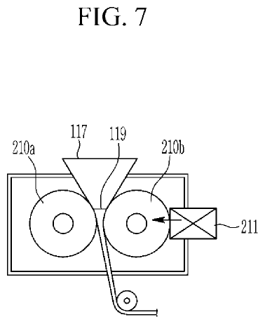

FIG. 6 is a schematic diagram of a mixing unit and a forming unit applied to a system for manufacturing an electrode for a solid state battery according to another exemplary embodiment of the present invention. FIG. 7 is a schematic diagram of a forming unit applied to a system for manufacturing an electrode for a secondary battery according to another exemplary embodiment of the present invention.

Referring to FIG. 6 and FIG. 1, a system for manufacturing an electrode for a secondary battery according to another exemplary embodiment includes a mixing unit 100, a forming unit 200, a pressurizing unit 400, and a winding roll 50, and a lamination unit 60 (refer to FIG. 1).

The mixing unit 100 includes a mixing chamber 110 that stores active material powder, binder powder, and conductive material powder.

At the present time, the mixing chamber 110 applied to a system for manufacturing an electrode for a secondary battery according to another exemplary embodiment of the present invention may be formed in a closed and sealed box shape. A mixing blade 111 rotatable by a drive motor M is disposed as the rotation member in an interior of the mixing chamber 110.

The mixing blade 111 is connected to the drive motor M located at a top portion of the mixing chamber 110, and may rotate inside the mixing chamber 110.

The mixing blade 111 rotates while maintaining a predetermined gap with an internal surface of the mixing chamber 110.

The mixing unit 100 is configured to form a powder mixture by mixing the active material powder, the binder powder, and the conductive material powder inside the mixing chamber 110, and to form a fibrillated mixture by fibrillating the powder mixture by a rotation of the mixing blade 111.

That is, the binder powder is dissolved as the mixing blade 111 rotates, and as the binder powder is dissolved, a binding force is generated between the active material powder and the active material powder, and between the active material powder and the conductive material powder, respectively.

Furthermore, a feeder 117 is connected to the mixing chamber 110 through a connection pipe 115.

The feeder 117 discharges the fibrillated mixture formed in the mixing unit 100 by a predetermined amount.

The fibrillated mixture is supplied into the feeder 117 through the connection pipe 115 connected to an upper end portion of the feeder 117. A cross-section of the feeder 117 becomes narrower toward the lower side, and has a discharge slot 119 at the lower end portion.

The discharge slot 119 may be formed with a slot length greater than or equal to the width of the winding roll 50.

Referring to FIG. 7, the forming unit 200 applied to a system for manufacturing an electrode for a secondary battery according to another exemplary embodiment includes a pair of forming rollers 210, and a pressurizing cylinder 211.

The pair of forming rollers 210 are disposed to both sides of the discharge slot 119 of the feeder 117.

The forming rollers 210 are configured to film the fibrillated mixture by squeezing, at both sides of the discharge slot 119, the fibrillated mixture discharged through the discharge slot 119 by a predetermined amount.

The pair of the forming rollers 210 may maintain a gap therebetween by the pressurizing cylinder 211.

That is, the pressurizing cylinder 211 operates to a first forming roller 210a among the pair of the forming rollers 210. That is, the pressurizing cylinder 211 pressurizes the first forming roller 210a such that the first forming roller 210a generates a pressurizing force toward a fixed second forming roller 210b.

Furthermore, the pressurizing cylinder 211 also functions as a damper when the fibrillated mixture passes between the pair of the forming rollers 210.

The cutting unit 300 is configured at a rear of the forming unit 200, and the pressurizing unit 400 is configured at a rear of the cutting unit 300.

The cutting unit 300 may be formed the same as the cutting unit in FIG. 3, and the pressurizing unit 400 may be formed the same as the pressurizing unit 40 in FIG. 1.

The electrode component film 70 having passed through the cutting unit 300 and the pressurizing unit 400 are wound on the winding roll disposed at the rear of the pressurizing unit 400. Afterwards, the electrode 80 for a secondary battery may be formed in the same way as in the exemplary embodiments described with reference to FIG. 1, FIG. 4, and FIG. 5.

An exemplary method for manufacturing the electrode 80 for a secondary battery may utilize a system for manufacturing an electrode for a secondary battery according to an exemplary embodiment of the present invention.

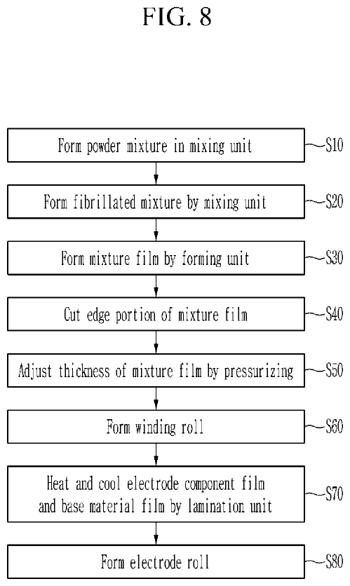

FIG. 8 is a flowchart showing a method for manufacturing an electrode for a secondary battery according to various exemplary embodiments of the present invention.

Referring to FIG. 8, at step S10, the active material powder, the binder powder, and the conductive material powder are supplied to the mixing chamber 11 to form a powder mixture.

Subsequently at step S20, the binder powder is dissolved by through the screw 16 or the mixing blade 111 inside the mixing chamber 11 or 110, and simultaneously, a binding force is generated between the active material powder and the active material powder, and between the active material powder and the conductive material powder, to transform the powder mixture to the fibrillated mixture.

The fibrillated mixture formed by the mixing unit 10 or 110 is supplied to the forming unit 20 or 200.

At the present time, the fibrillated mixture may be automatically supplied to the forming unit 20 by operation of the screw 16. Alternatively, the fibrillated mixture may be supplied to the forming unit 200 by the feeder 117 by a predetermined amount.

Subsequently at step S30, the fibrillated mixture is filmed by generating a shear force to the fibrillated mixture through the forming unit 20 or 200.

At the present time, the forming unit 20 or 200 includes the forming frame 21 or the forming rollers 210, and pressurizes the fibrillated mixture to transform the fibrillated mixture to the mixture film 71 in a film shape.

Subsequently at step S40, both side edges of the mixture film 71 formed by the forming unit 20 are uniformly cut by the cutting unit 30 or 300.

Subsequently at step S50, the thickness of the mixture film 71 is made uniform by supplying the mixture film 71 to the pressurizing unit 40 or 400.

That is, the thickness of the mixture film 71 becomes uniform while the mixture film 71 passes through the pair of pressurizing rollers 41 of the pressurizing unit 40.

Subsequently at step S60, the electrode component film 70 is wound on the winding roll 50 by a predetermined length.

Subsequently at step S70, while the base material film roll 55 is located between the two winding rolls 50a and 50b, the first electrode component film 70a wound on the first winding roll 50a, the base material film 75 wound on the base material film roll 55, and the second electrode component film 70b wound on the second winding roll 50b are released and supplied to the lamination unit 60.

At the present time, the first electrode component film 70a, the base material film 75, and the second electrode component film 70b consecutively stacked.

Subsequently, the first electrode component film 70a, the base material film 75, and the second electrode component film 70b are heated and cooled in the lamination unit 60 to form a junction thereof, forming the electrode 80 for a secondary battery.

At the present time, as shown in FIG. 4, the first electrode component film 70a, the base material film 75, and the second electrode component film 70b stacked together may be heated simultaneously through the heating portion 63 of the lamination unit 60.

Alternatively, as shown in FIG. 5, after heating the base material film 75 through the heating portion 63 of the lamination unit 60, the heated base material film 75 is located between and joined with the first electrode component film 70a and the second electrode component film 70b, and then the junction is cooled through the cooling portion 65.

Finally at step S80, the laminated films in the order of the first electrode component film 70a, the base material film 75, and the second electrode component film 70b are wound onto the electrode roll 85 for a secondary battery by predetermined length.

The electrode 80 for a secondary battery wound on the electrode roll 85 for a secondary battery may be cut or formed into a predetermined shape, and then impregnated with a liquid/polymer electrolyte to form a battery using lithium ions or transferred with solid electrolyte to form a solid state battery.

Therefore, according to system and method for manufacturing an electrode for a secondary battery according to various exemplary embodiments of the present invention, since a double-sided electrode 80 for a secondary battery is manufactured by use of a dry process, the thickness of the electrode 80 of the battery may be reduced, increasing a volumetric efficiency of the electrode 80 and improving the energy density of the battery.

Furthermore, system and method for manufacturing an electrode for a secondary battery according to various exemplary embodiments of the present invention, the usage of base material and separators required in manufacturing a secondary battery are reduced, reducing the material cost.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for manufacturing an electrode for a secondary battery, the system comprising:
a mixing unit supplied with active material powder, binder powder, and conductive material powder, forming a fibrillated mixture by fibrillating a powder mixture of the active material powder, the binder powder, and the conductive material powder, and discharging the fibrillated mixture therefrom;
a forming unit configured to form a mixture film by the fibrillated mixture discharged from the mixing unit;
a pressurizing unit supplied with the mixture film from the forming unit and uniformizing a thickness of the mixture film by a pair of pressurizing rollers to form an electrode component film;
a first winding roll and a second winding roll each supplied with the electrode component film from the pressurizing unit and winding the electrode component film;
a base material film roll located between first and second winding rolls and wound with a base material film; and
a lamination unit supplied with a first electrode component film from the first winding roll, a base material film from the base material film roll, and a second electrode component film from the second winding roll, and configured to heat and cool the first electrode component film, the base material film, and the second electrode component film that are consecutively stacked to form a junction of the first electrode component film, the base material film, and the second electrode component film that are consecutively stacked.

2. The system of claim 1, wherein the mixing unit includes:
a mixing chamber formed in a cylindrical shape, supplied with the active material powder, the binder powder, and the conductive material powder, and having a rear end portion tapered to form an outlet having a slot to discharge the fibrillated mixture therefrom; and
a rotation member disposed in a longitudinal direction inside the mixing chamber, and connected to a drive motor to be rotatable by the drive motor, and fibrillating the powder mixture by dissolving the binder powder to generate a binding force between the active material powder and the active material powder, and between the active material powder and the conductive material powder.

3. The system of claim 2, wherein the rotation member includes a screw fixedly mounted on the rotation member, a diameter of the screw increasing toward a downstream side of the screw so that a gap between the screw and an internal surface of the mixing chamber is narrowed toward the downstream side thereof.

4. The system of claim 2, wherein the mixing unit further includes a preheating chamber that surrounds a predetermined range of an external surface of the mixing chamber, and provides heat to the powder mixture inside the mixing chamber.

5. The system of claim 2, wherein the forming unit is configured at a rear of the mixing unit, and films the fibrillated mixture discharged from the mixing chamber by a forming frame connected to the outlet.

6. The system of claim 5, wherein
the forming frame includes an upper frame and a lower frame that are detachable with each other; and
a shape of the fibrillated mixture is varied by varying a forming slit between the upper frame and lower frame.

7. The system of claim 1, wherein the mixing unit includes:
a mixing chamber formed in a closed box shape and storing the active material powder, the binder powder, and the conductive material powder therein;
a rotation member disposed inside the mixing chamber, connected to a drive motor and rotated by the drive motor outside the mixing chamber to dissolve the binder powder to fibrillate the powder mixture; and
a feeder connected to the mixing chamber through a connection pipe, and configured to discharge the fibrillated mixture formed by the rotation member through a discharge slot formed at a lower end portion of the feeder.

8. The system of claim 7, wherein the rotation member includes a mixing blade maintaining a predetermined gap with an internal surface of the mixing chamber.

9. The system of claim 7, wherein the discharge slot is formed with a slot length greater than or equal to a width of the first and second winding rolls.

10. The system of claim 7, wherein the forming unit includes
a pair of forming rollers configured to film the fibrillated mixture by squeezing, at a first side and a second side of the discharge slot, the fibrillated mixture discharged through the discharge slot; and
a pressurizing cylinder pressing a first forming roller of the pair of forming rollers toward a second forming roller of the pair of forming rollers to generate a pressurizing force.

11. The system of claim 1, further including a cutting unit disposed between the forming unit and pressurizing unit, and configured to uniformly cut first and second side edges of the mixture film supplied from the forming unit to the pressurizing unit.

12. The system of claim 1, wherein the lamination unit includes a heating portion configured to heat a stack of the first electrode component film, the base material film, and the second electrode component film to form adhesiveness of binder contained in the first electrode component film and the second electrode component film.

13. The system of claim 1, wherein the lamination unit includes:
a heating portion configured to heat the base material film supplied from the base material film roll prior to stacking the base material film between the first electrode component film and the second electrode component film; and
a cooling portion configured to cool the first electrode component film and the second electrode component film joined with and heated by the base material film.

14. A method for manufacturing an electrode for a secondary battery, the method including:
forming, by a mixing unit, a fibrillated mixture by fibrillating a powder mixture of active material powder, binder powder, and conductive material powder;
forming a mixture film by filming the fibrillated mixture supplied from the mixing unit by a pressurizing force of a forming unit;
forming a first electrode component film and a second electrode component film by uniformizing a thickness of the mixture film by a pair of pressurizing rollers of a pressurizing unit;
winding the first electrode component film on a first winding roll and the second electrode component film on a second winding roll; and
forming an electrode for the secondary battery by forming junction by heating, laminating, and cooling a consecutive stack of the first electrode component film, a base material film, and the second electrode component film that are supplied from the first winding roll, a base material film roll, and the second winding roll, respectively.

15. The method of claim 14, wherein the forming of the fibrillated mixture includes:
supplying the active material powder, the binder powder, and the conductive material powder to a mixing chamber of the mixing unit; and
generating a binding force between the active material powder and the active material powder and between the active material powder and the conductive material powder by dissolving the binder powder between the mixing chamber and a rotation member inside the mixing chamber.

16. The method of claim 14, further including, after forming the mixture film and before forming the first and second electrode component films, uniformly cutting first and second side edges of the mixture film by a cutting unit.

17. The method of claim 14, wherein the forming of the electrode for the secondary battery includes:
disposing the base material film roll between the first winding roll and the second winding roll;
supplying the first electrode component film, the base material film, and the second electrode component film to a lamination unit in a consecutive stack; and
laminating the consecutive stack of the first electrode component film, the base material film, and the second electrode component film.

18. The method of claim 17, further including, after forming the electrode for the secondary battery, winding the electrode for the secondary battery on an electrode roll.
